(19) United States
(12) Patent Application Publication
(10) Pub. No.: US 2010/0322246 A1
(43) Pub. Date: Dec. 23, 2010

(54) DISTRIBUTED OPERATION

(75) Inventors: Mikko Rinne, Espoo (FI); David Randall, Romsey (GB); Angelo Centoza, Winchester (GB)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/532,832

(22) PCT Filed: Mar. 25, 2008
(86) PCT No.: PCT/EP08/53506

§ 371 Date: Jun. 14, 2010

(30) Foreign Application Priority Data
Mar. 23, 2007 (GB) 0705547.8

(51) Int. Cl. H04L 12/56

(52) U.S. Cl. 370/392

(57) ABSTRACT

A method comprises determining that at least one data portion is missing from a first data set; the first data set comprising a plurality of data portion; creating a second data set having a plurality of parts from the plurality of data portions; inserting an indicator for each data portion in the second data set; the indicator indicating the end of the respective data portion; and calculating which parts of the second data set are affected by one or more data portions which have not been received.

This invention relates to enabling segmentation and concatenation in distributed macro diversity architecture.

This invention is particularly concerned with UTRAN Long-Term Evolution (LTE), also known as 3.9 G, or Evolved UTRAN and provision of Multimedia Broadcast/Multicast Services (MBMS) therein. The need for a solution arises from recent architecture discussions in 3GPP (3^{rd} generation partnership project), regarding whether segmentation and concatenation of MBMS services should be performed in a centralized network node (in current 3GPP SAE architecture User Plane Entity (UPE), or the base stations (eNB). The invention also builds on the 3 GPP-agreed plan to provide Single-Frequency Network (SFN) operation for MBMS, in which macro diversity gain is reached by transmitting exactly the same signals from all the eNBs belonging to the SFN area.

For multicell reception to work properly in a terminal receiving the signal from an SFN, exactly the same bits need to be transmitted from all the eNBs belonging to the SFN within a time period defined by a cyclic prefix (CP) of the OFDM (orthogonal frequency division multiplexing) signal, signal propagation and inter-site distance. During proper operation the signals from several eNBs combine in the terminal receiver in the same way as if they were multipath components originating from the same eNB. If different bits are sent from different eNBs, the signals interfere destructively.

Segmentation refers to the operation where a service data unit (SDU) from a higher layer is fragmented into smaller protocol data units (PDU) for processing by the lower layer. Concatenation refers to the process, where in the case of fixed-size PDUs the head of a new SDU is appended to the tail of the previous SDU in order to avoid wasted capacity due to padding. Both segmentation and concatenation have to be specified as reversible processes so that the receiving entity can correctly reconstruct the SDUs for submission to the higher layer.

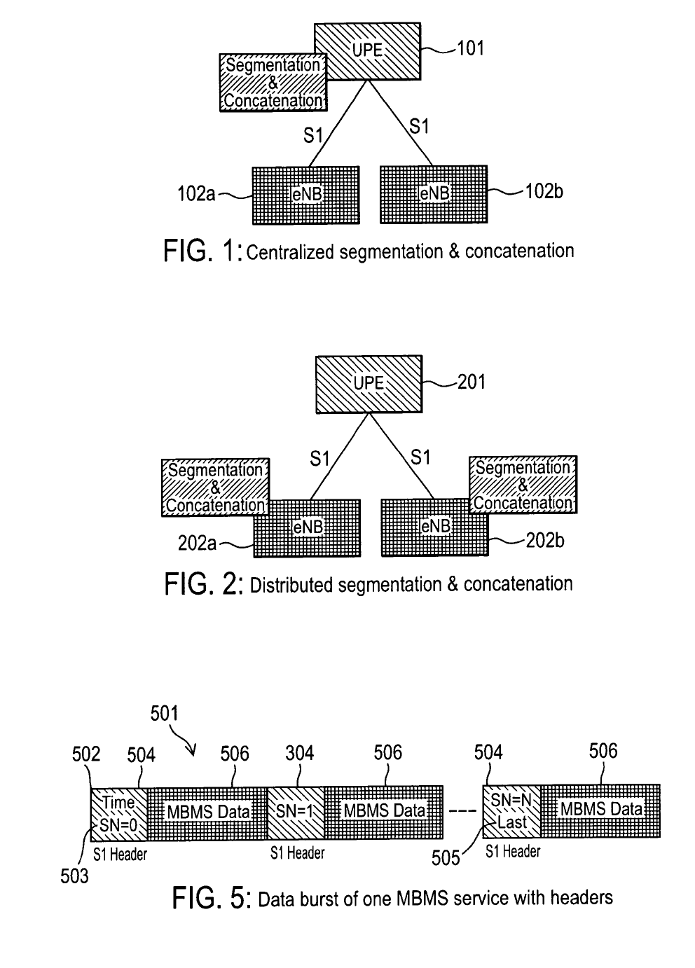

In 3GPP two main candidate architectures for data synchronization have been discussed. In a centralized solution as the one illustrated in FIG. 1, segmentation and concatenation of higher layer packets (generally IP-packets) into transport blocks suitable for radio transmission takes place in a centralized node 101 (in FIG. 1 referred to as “UPE”=User Plane Entity). This ensures that all the eNBs 102a, 102b receive identical frames for radio transmission. This type of architecture is used e.g. in UTRAN Release 6 MBMS, where a Radio Network Controller (RNC) hosts the segmentation and concatenation function assuming the role of UPE in FIG. 1.

Regarding LTE (Long term evolution), it has been decided that for cellular point-to-point operation (hereforth referred to as “unicast” for the purposes of this document) the segmentation and concatenation functions are hosted by the eNBs, 202a, 202b as shown in FIG. 2. There is a clear trend in many companies to align MBMS operation with this unicast architecture as much as possible. In particular, to align the two architectures, the necessity of a centralized node corresponding to RNC should be avoided. Therefore a strong architecture candidate proposal has segmentation & concatenation functions distributed to eNodeBs. To ensure correct SFN (single frequency network) operation, it needs to be specified that these segmentation and concatenation functions in different eNodeBs perform identically and are able to recover from e.g. the case of lost packets due to transmission problems on the S1 interface.

In the case of distributed segmentation/concatenation, when a packet is lost on the S1 interface, the eNB is able to calculate how many bytes that packet was going to occupy (including MAC header). Subsequent to the loss, the eNB keeps creating transport blocks (TB) with the rest of the received packets and fits them into radio frames, as if no loss had occurred at all. In this way transmission in SFN mode is preserved as all eNBs will still transmit the same information at the same time, apart from the lost or delayed packets.

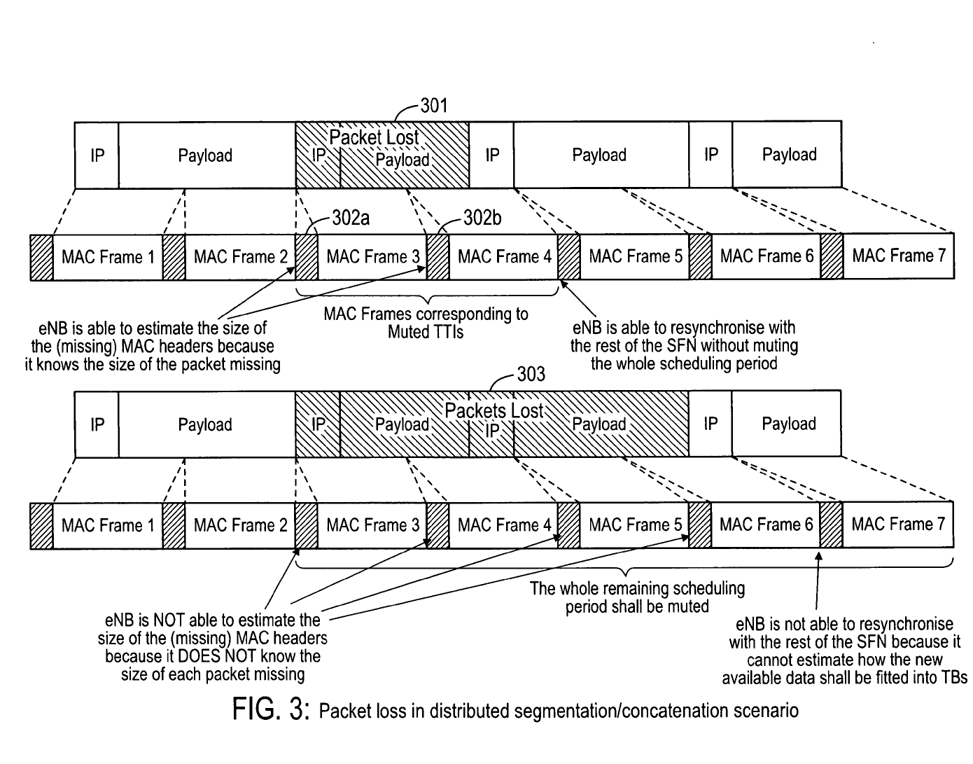

FIG. 3 shows packet loss in a distributed segmentation/concatenation scenario. With the help of header information counting the number of bytes in each SDU and the number of higher layer packets attached to each frame on the S1 interface, the eNB is able to know 1) how many packets have been lost, and 2) what was the total size of the one or more missing IP packets. If one packet is lost, the eNB can detect the size of the packet 301 and it can calculate the MAC header(s) 302a, 302b that would eventually be generated by segmenting/concatenating that packet. Although the eNB will have to mute the radio frames affected by the lost packet, it will be able to restart transmitting radio frames with new received data in full SFN synchronization.

However, if multiple packets are lost in sequence, as shown in FIG. 3, the eNB would only be able to deduce the number of lost packets 303 and the total amount of lost data, but not the exact length of each of the packets lost.

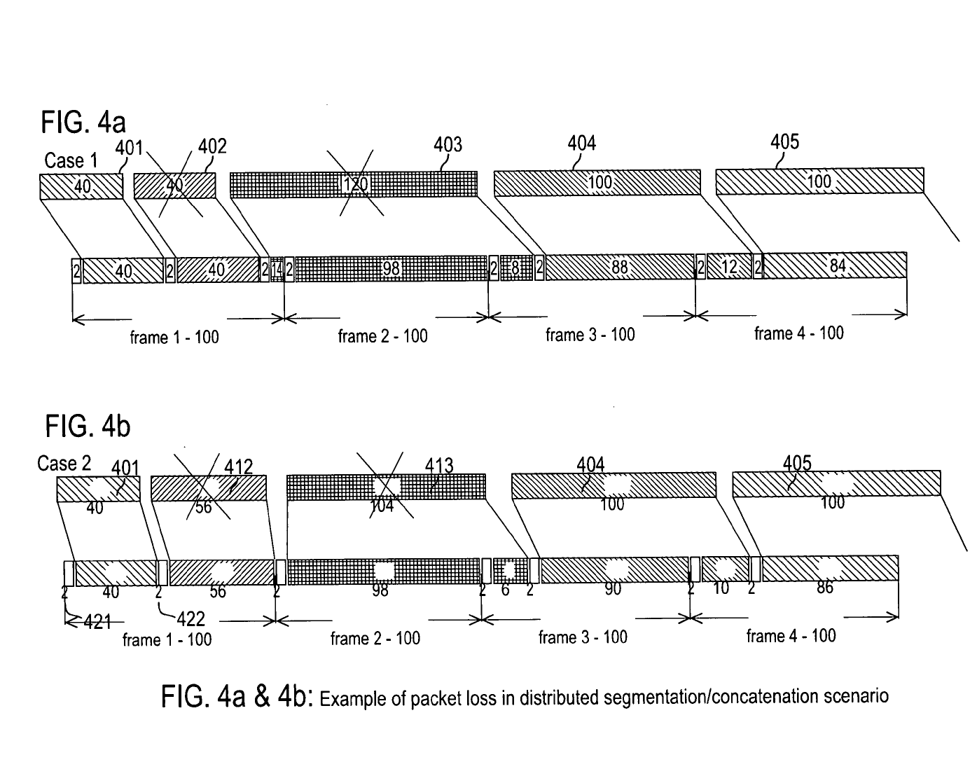

The resulting problem case is illustrated in FIGS. 4a and 4b. Five example packets are shown in FIGS. 4a and 4b. In this example, the fixed lower layer PDU size created for the radio interface is 100 octets. In both case 1 and case 2, the total size of the second 402, 412 and third packets 403, 413 of the data flow consist of 160 octets. For case 1, there are 40 octets+120 octets and for case 2, there are 56 octets+104 octets. If both of these data packets 402, 412; 403, 413 were erased on the S1 interface, the impacted eNB would know at the time of receiving the fourth packet 404 that two packets containing 160 octets of data have been lost. For proper operation all eNBs need to be able to create identical frames from frame 4 onwards, independent of how the total number of octets was split between packets two 402, 412 and three 403, 413.

However, the example in FIG. 4 shows that there is an offset of two octets between cases 1 and 2. This alone causes eNB2, which received se2- and which assumes the lost packets 402, 403 were as in case 1, to transmit different data, interfere destructively, and destroy SFN gain between their corresponding cells.
In normal cases of segmentation and concatenation according to e.g. 3GPP release 99 RLC (Radio Link Control), the following holds:
If SDU1 ends in the current radio frame, a length indicator (LI) is added. This LI tells the length of the segment of SDU1 in the PDU, after which SDU2 starts by default. If there is no more data to transmit, another LI with a special value indicating padding can be inserted.
If SDU1 fills the space to the end of the PDU and continues to the next PDU, no LI is added.

Therefore in these normal cases exactly one LI is added per SDU (apart from the case of padding occurring at the end of a data burst, but this is insignificant in the case of losing the final packet, because the next data burst will start in a uniform way).

The problem occurs, because in case 2, the first 401 and second packet 412, plus their respective header fields 421, 422, exactly fill radio frame 1. If nothing is done, the receiver doesn't know, whether there is an SDU border between frame 1 and frame 2, or if the SDU continues to radio frame 2. For this case two methods exist:

1) Insert a special-valued LI to frame 1 with an agreed meaning, that the SDU continues to radio frame 2. Due to the addition of the LI, an amount of data equal to the length of the LI field is pushed to radio frame 2. In radio frame 2, insert an LI to signal the length of the remaining segment. This works without problems in unicast, but in SFN operation the described problem due to packet erasure occurs, because two LIs were inserted for one SDU, and this is only known, if the exact length of each lost packet is known.

2) Have a flag, in the fixed-size part of the radio frame header, telling when the SDU exactly ends in the frame. This time, no LI at all is inserted for this SDU (one LI less than the normal case) and again in the case of uncertainty about exact length of each lost packet, different eNBs can be offset by the length of one LI field.

The above problem has not been addressed in architecture proposals so far and needs to be solved if distribution of segmentation and concatenation is concluded upon.

Previous architectures are not prone to this problem, for example:

1) Unicast transmission with distributed segmentation and concatenation: For unicast distributed operation is not a problem, because each base station is sending a different signal to a different user. There is no requirement for uniform operation as long as the transmitting and receiving entities correctly understand each other and are able to re-synchronize after lost frames.
2) MBMS macro diversity transmission with centralized segmentation & concatenation. Rel-6 MBMS supports macro diversity, in which more than one NodeB transmits the same signal. In the WCDMA architecture, however, segmentation and concatenation are terminated in the Radio Network Controller (RNC) in the network, and therefore centralized segmentation & concatenation assumption applies.

A more general case of the use of special length indicator values is described in EP1119948. This describes the approach of using special values of length indicators, which is used e.g. in 3GPP release 99 RLC and EDGE RLC/MAC.

It is an aim of embodiments of the invention to address at least one of the disadvantages or problems discussed above.

Accordingly, the present invention provides an addition to the segmentation & concatenation scheme to enable distributed operation by ensuring uniform operation of all the eNBs even in the case of packet loss. The main principle is to ensure that in all cases exactly one length indicator field is created for each transmitted SDU. Following these guidelines it is possible for eNBs to accurately and uniformly continue segmentation and concatenation operations even after multiple erased packets.

In a first aspect of the present invention there is provided a method comprising;
determining that at least one data portion is missing from a first data set; the first data set comprising a plurality of data portions,
creating a second data set having a plurality of parts from the plurality of data portions;
inserting an indicator for each data portion in the second data set; the indicator indicating the end of the respective data portion; and
calculating which parts of the second data set are affected by one or more data portions which have not been received.
   Preferably the method further comprises:

receiving the first data set over an interface and
transmitting the parts of the second data set after the affected parts for subsequently received data portions.
   Preferably the indicator comprises a flag indicating that the data portion ends exactly at the end of a data part.
   Preferably the flag is located in a fixed-sized header of the data part.
   Preferably the indicator further comprises a dummy segment appended to the start of a following data part.
   Preferably the indicator comprises a special value indicating that the data portion ends in the next data part.
   Preferably the indicator comprises a data segment of a predetermined length which indicates part of a data portion of the same length as the segment starts in the following data part.
   Preferably the beginning of the first data set comprises a timestamp indicating the start of the first one data set.
   Preferably each data portion has a sequence number.
   Preferably the last portion of the first data set comprises a last portion flag.
   Preferably the method further comprises creating dummy parts and inserting them into the second data set, as if the data portion has been received.
   Preferably the creating the second data set comprises segmenting and concatenating the data portions of the first data set in to the data parts of the second data set.
   Preferably the data parts of the second data set have a different size to the data portions of the first data set.
   Preferably the transmitting is carried out by enhanced node Bs.
   Preferably the transmitting is carried out by network nodes being a part of a single frequency network.
   Preferably the second data set is transmitted at the same time by a plurality of network nodes.
   Preferably network nodes are broadcasting and/or multicasting the second data set.
   Preferably the data portions are received from a centralized node.
   Preferably the interface is an S1 interface.
   Preferably the second data set is transmitted over an E-UTRAN.
   Preferably the indicator is a length indicator.
   Preferably the first data set is at least one data burst.
   Preferably the data portions are data packets of at least one data burst.
   Preferably the parts of the second data set are radio frames.
   In a second aspect of the present invention there is provided a method comprising;
segmenting a plurality of data portions;
generating a data set for transmitting over an interface by concatenating the segments of the data portions into plurality of data parts;
adding an indicator for each data portion to indicate the end of the respective data portion.
   In a third aspect of the present invention there is provided an apparatus comprising:
a processor configured to determine that at least one data portion is missing from a first data set; the first data set comprising a plurality of data portions,
a processor configured to create a second data set having a plurality of parts from the plurality of data portions;
a processor configured to insert an indicator for each data portion in the second data set; the indicator indicating the end of the respective data portion; and
a processor configured to calculate which parts of a second data set are affected by one or more data units which have not been received on the basis of the indicators.
   In a fourth aspect of the present invention there is provided an apparatus comprising;
a processor configured to segment a plurality of data portions;
a processor configured to generate a data set for transmitting over an interface by concatenating the segments of the data portions into plurality of data parts;
a processor configured to add an indicator for each data portion to indicate the end of the respective data portion.
   In a fifth aspect of the present invention there is provided a computer program configured to perform the following when the program is run on a computer:
determining that at least one data portion is missing from a first data set; the first data set comprising a plurality of data portions,
creating a second data set having a plurality of parts from the plurality of data portions;
inserting an indicator for each data portion in the second data set; the indicator indicating the end of the respective data portion; and
calculating which parts of the second data set are affected by one or more data portions which have not been received.
   According to a further aspect of the present invention there is provided a method comprising;
receiving a data burst over an interface; the first data set comprising a plurality of data packets,
creating a second data set having a plurality of frames from the plurality of data packets;
inserting a length indicator for each data packet in the second data set; the indicator indicating the end of the respective data packet;
determining that at least one data packet has been not been received over the interface;
calculating which frames of the second data set are affected by one or more data packets which have not been received;
transmitting the frames of the second data set after the affected frames for subsequently received data packets.
   According to a yet further aspect of the present invention there is provided a method comprising segmenting a plurality of data packets;
generating a data set for transmitting over a radio interface by concatenating the segments of the data packets into a plurality of frames;
adding a length indicator for each data packet to indicate the end of the respective data packet.
   According to another aspect of the present invention there is provided an apparatus comprising
an input configured to receive a data burst over an interface; the first data set comprising a plurality of data packets,
a processor configured to create a second data set having a plurality of frames from the plurality of data packets;
a processor configured to insert a length indicator for each data packet in the second data set; the indicator indicating the end of the respective data packet;
a processor configured to determine that at least one data packet has been not been received over the interface;
a processor configured to calculate which frames of the second data set are affected by one or more data packets which have not been received;
a processor configured to transmit the frames of the second data set after the affected frames for subsequently received data packets.
   According to another aspect of the present invention there provided an apparatus comprising
a processor configured to segment a plurality of data packets;
a processor configured to generate a data set for transmitting over a radio interface by concatenating the segments of the data packets into a plurality of frames;
a processor configured to add a length indicator for each data packet to indicate the end of the respective data packet.

FIG. 1 illustrates centralised segmentation and concatenation;

FIG. 2 illustrates distributed segmentation and concatenation;

FIG. 3 illustrates an example of packet loss in a distributed segmentation/concatenation scenario;

FIGS. 4a and 4b shows another example of packet loss in a distributed segmentation/concatenation scenario; and,

FIG. 5 illustrates an example of a data burst of one MBMS service with headers.

The present invention is described herein with reference to particular illustrative embodiments. However, such embodiments are presented for the purposes of illustrating the present invention, and does not limit the scope thereof.

A content synchronization scheme for ensuring that the same data gets transmitted from all the base stations at the same time is also needed, and the following proposal has been discussed in 3GPP and is shown with respect to FIG. 5.

1) Assume the data to be transmitted in separable bursts 501. An example can be the amount of data needed by the MBMS service during one second. If MBMS services are time-multiplexed with each other, the data bursts are sent from each active MBMS service (on the same frequency layer) after each other, and after the example period of one second, a subsequent burst of the first service would be provided.

2) The beginning of the burst carries a timestamp 502 on the S1 interface. This timestamp is absolutely understood by all participating eNBs. The timestamp also works as an implicit start-of-burst indicator, so that the eNB becomes aware that a new burst is starting. In the start of burst, a sequence number for packets 506 belonging to the packet burst is reset (e.g. starting from SN 0).

3) Throughout the burst, the sequence number 503 of the packets is sequentially increased.

4) The last packet of the burst includes a special “Last packet” indicator flag 505.

5) if any packet of the data burst is missing (or delayed beyond the point where it should have been sent), no further data is sent by the impacted base station until the end of the data burst. A missing packet can be detected by the occurrence of an incomplete radio interface frame (no more data), even though no “last packet” flag has been set, or a missing sequence number.

This scheme has further been enhanced in 3 GPP discussions by adding an octet counter element to the header 504, which shows how many octets of SDU data has lapsed. With this octet counter the scheme is argued to work around the problem of point 5) above, i.e. be able to resume transmission after a lost packet or packets.

While this content synchronization scheme (known a priori and contributed to 3GPP by e.g. Alcatel and NTT DoCoMo as described in Refs: [1], [2]) provides a basic framework for the invention, also other types of content synchronization schemes can be used together with the invention.

[1] R3-061583, Text Proposal ‘Architecture for Content Synchronisation’, Alcatel, NTT DoCoMo, Nokia

[2] R3-061661, Content synchronization scheme with segmentation and 30 concatenation in eNB, NTT DoCoMo

Two examples are described below.

1) A “tail indicator” flag is added to the fixed-size part of a MAC header. This flag is set (at least) every time, when the SDU exactly ends in the end of the PDU. The following PDU starts with a dummy LI (zero-length segment) to produce the required exactly one L1 per SDU to remain in sync. However, an additional flag in the fixed-part MAC-header of all multi-cell MBMS MAC-PDUs is required, even though the case for which it covers is rather rare.

2) An alternative is to define for the special LI value, which is inserted into PDU n, that the SDU continues for one <length-of-LI-field> in PDU n+1. PDU n+1 will then start with this remainder of the previous SDU and next SDU will start without any explicit indication in PDU n+1.
Solution 1) is preferable because it is self-contained, i.e. each PDU is separately understandable to the receiver. If the receiver misses PDU n in the case of solution 2), PDU n+1 will be ambiguous, which is a less desirable way of operation.

The example implementation considered here is E-UTRAN (or UTRAN LTE), providing MBMS services in multicell environment with segmentation and concatenation functions distributed to base stations. This may include the termination of RLC and MAC protocol layers to eNBs, or the use of a separate layer for segmentation and concatenation.

The advantage of the present invention is that segmentation and concatenation operation is enabled in a distributed architecture.
A standard-compliant base station keeps segmentation & concatenation in synch and operates according to the invention, when an SDU (IP-packet) matching the exact size of a transport block (TB) is provided.
   In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.
   The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions.
   The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi-core processor architecture, as non-limiting examples.
   Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.
   The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims.
   For example the present invention may be applied to two identical domains, such as two packet switched domains. Alternatively, there may be two different types of domains like a circuit switch domain and a packet switched domain. In another embodiment, there may be two packet switched domains, but the types and composition of the packets are different.
   However, all such and similar modifications of the teachings of this invention will still fall within the scope of this invention as defined in the appended claims. Glossary

### 3GPP 3^{rd} Generation Partnership Project

### CP Cyclic Prefix

EDGE Enhanced Data rates for GSM Evolution
eNB evolved Node B (LTE base station)

### E-UTRAN Evolved UTRAN

### LTE Long-Term Evolution [of UTRAN]

### MAC Medium Access Control

MBMS Multimedia Broadcast/Multicast Service (as defined in 3GPP)

### OFDM Orthogonal Frequency Division Multiplexing

### PDU Protocol Data Unit

### RLC Radio Link Control

### RNC Radio Network Controller

### SAE System Architecture Evolution

### SDU Service Data Unit

### SFN Single Frequency Network

### UMTS Universal Mobile Telecommunication System

### UPE User Plane Entity

### UTRAN UMTS Terrestrial Radio Access Network

WCDMA Wideband Code Division Multiple Access

1-29. (canceled)

30. A method comprising;
receiving a first data set over an interface; the first data set comprising a plurality of data portions,
creating a second data set having a plurality of parts from the plurality of data portions;
inserting an indicator for each data portion in the second data set; the indicator indicating the end of the respective data portion;
determining that at least one data portion has been not been received over the interface;
calculating which parts of the second data set are affected by one or more data portions which have not been received; and
transmitting the parts of the second data set after the affected parts for subsequently received data portions.

31. A method according to claim 30 wherein the indicator comprises one of a flag indicating that the data portion ends exactly at the end of a data part and a special value indicating that the data portion ends in the next data part.

32. A method according to claim 31 wherein the flag is located in a fixed-sized header of the data part.

33. A method according to claim 32 wherein the indicator further comprises at least one of a dummy segment appended to the start of a following data part and a data segment of a predetermined length which indicates part of a data portion of a same length as the segment starts in the following data part.

34. A method according to claim 30 wherein the beginning of the first data set comprises a timestamp indicating a start of the first one data set.

35. A method according to claim 30 wherein each data portion has a sequence number.

36. A method according to claim 30, wherein the last portion of the first data set comprises a last portion flag.

37. A method according to claim 36, further comprising creating dummy parts and inserting them into the second data set, as if the data portion has been received.

38. A method according to claim 37, wherein the creating the second data set comprises segmenting and concatenating the data portions of the first data set into the data parts of the second data set.

39. A method according to claim 38, wherein the data parts of the second data set have a different size to the data portions of the first data set.

40. A method according claim 39, wherein the transmitting is carried out by network nodes being a part of a single frequency network.

41. A method according to claim 40, wherein the second data set is transmitted at the same time by a plurality of network nodes and the data portions are received from a centralized node.

42. A method according to claim 41, wherein network nodes are configured to perform at least one of broadcasting and multicasting the second data set.

43. A method according to claim 30 wherein the interface is an S1 interface

44. A method according to claim 30, wherein the second data set is transmitted over an E-UTRAN.

45. A method according to claim 30, wherein the indicator is a length indicator.

46. A method according to claim 30, wherein the first data set is at least one data burst, the data portions are data packets of at least one data burst and parts of the second data set are radio frames.

47. An apparatus comprising
an input configured to receive a first data set over an interface; the first data set comprising a plurality of data portions,
a processor configured to create a second data set having a plurality of parts from the plurality of data portions;
a processor configured to insert an indicator for each data portion in the second data set; the indicator indicating the end of the respective data portion;
a processor configured to determine that at least one data portion has been not been received over the interface;
a processor configured to calculate which parts of the second data set are affected by one or more data portions which have not been received; and
an output configured to transmit the parts of the second data set after the affected parts for subsequently received data portions.

48. An apparatus comprising:
a processor configured to segment a plurality of data portions;
a processor configured to generate a data set for transmitting over an interface by concatenating the segments of the data portions into plurality of data parts; a processor configured to add an indicator for each data portion to indicate the end of the respective data portion.
